(19) United States
(12) Patent Application Publication
(10) Pub. No.: US 2009/0135584 A1
(43) Pub. Date: May 28, 2009

(54) LIGHT EMITTING MODULE

(76) Inventor: Jia-Chang LIN, Pingtung County (TW)

Correspondence Address: BIRCH STEWART KOLASCH & BIRCH, PO BOX 747, FALLS CHURCH, VA, 22040-0747, US

(21) Appl. No.: 12/274,265

(22) Filed: Nov. 19, 2008

(30) Foreign Application Priority Data
Nov. 23, 2007 (TW) 096144647

(51) Int. Cl. F21V 23/00

(52) U.S. Cl. 362/97.1

(57) ABSTRACT

A light emitting module includes a back plate, at least one fluorescent lamp, a circuit board and a transforming unit. The fluorescent lamp is disposed on a surface of the back plate and has an electrode wire. The circuit board is disposed on the other surface of the back plate. The transforming unit is disposed on the circuit board and has at least one pin. The electrode wire connects with the pin directly.

### CROSS REFERENCE TO RELATED APPLICATIONS

This Non-provisional application claims priority under 35 U.S.C. §119(a) on Patent Application No(s). 096144647 filed in Taiwan, Republic of China on Nov. 23, 2007, the entire contents of which are hereby incorporated by reference.

### BACKGROUND OF THE INVENTION

1. Field of Invention

The invention relates to a light emitting module and, in particular, to a light emitting module with a transforming unit.

2. Related Art

Accompanying the digital technology, various kinds of flat displays are rapidly developed. In these flat displays, the light emitting module is an indispensable component. For example, in a liquid crystal display (LCD), the light emitting module is needed to serve as a backlight module for providing light source. Of course, except the backlight module, the light emitting module can also be used as the illumination device or outdoor media board.

The direct-type backlight module of the LCD will be described for illustrating the conventional light emitting module. As shown in FIG. 1, the conventional light emitting module 1 includes a back plate 11, a plurality of fluorescent lamps 12, a driving circuit board 13 and a diffuser 14. The fluorescent lamps 12 and the driving circuit board 12 are disposed at opposite sides of the back plate 11, respectively, and the diffuser 14 is disposed adjacent to the fluorescent lamps 12.

The driving circuit board 13 has a plurality of transformers T (shown as the dotted line). Each transformer T is electrically connected with a connecting terminal 17. Two ends of the fluorescent lamp 12 are disposed with a plurality of high-voltage flexible wires 15, which are welded to the electrode wires (not shown) of the fluorescent lamp 12 and connected with a connector 16. The fluorescent lamp 12 can electrically connected with the connecting terminals 17 of the driving circuit board 13 through the connector 16, so that the high-voltage signal outputted from the transformer T can be transmitted to the fluorescent lamp 12 so as to drive the fluorescent lamp 12 to emit light.

However, regarding to the light emitting module 1, each fluorescent lamp 12 needs the corresponding connector 16 and high-voltage flexible wires 15, and the corresponding connecting terminal 17 disposed on the driving circuit board 13 is required Thus, the material cost as well as the loading for controlling the raw materials is increased.

Therefore, it is an important subject to provide a light emitting module that does not need the high-voltage flexible wire and connector so as to decrease the cost and simplify the control of raw materials.

### SUMMARY OF THE INVENTION

In view of the foregoing, the present invention is to provide a light emitting module without the high-voltage flexible wire and connector.

To achieve the above, the present invention discloses a light emitting module including a back plate, at least one fluorescent lamp, a circuit board and a transforming unit. The fluorescent lamp is disposed on a surface of the back plate and has an electrode wire. The circuit board is disposed on another surface of the back plate. The transforming unit is disposed on the circuit board and has at least one pin, and the electrode wire is connected with the pin directly.

As mentioned above, in the light emitting module of the invention, the electrode wire of the fluorescent lamp is directly connected with the pin of the transforming unit, so that the fluorescent lamp can emit light according to the high-voltage signal from the transforming unit. Compared with the prior art, the present invention does not need the expensive high-voltage flexible wire and connector, and the connecting terminals disposed on the driving circuit board are not necessary. Thus, the present invention can sufficiently decrease the material cost and simplify the control of the raw materials.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic illustration of a conventional light emitting module;

FIG. 2 is a schematic illustration of a light emitting module according to a preferred embodiment of the invention;

FIG. 3 is a sectional view showing a part of the light emitting module of the embodiment of the invention;

FIGS. 4 and 5 are top views of light emitting modules according to the embodiment of the invention; and

FIG. 6 is a schematic illustration of another light emitting module according to the embodiment of the invention, wherein the transforming unit has the pins of different aspect.

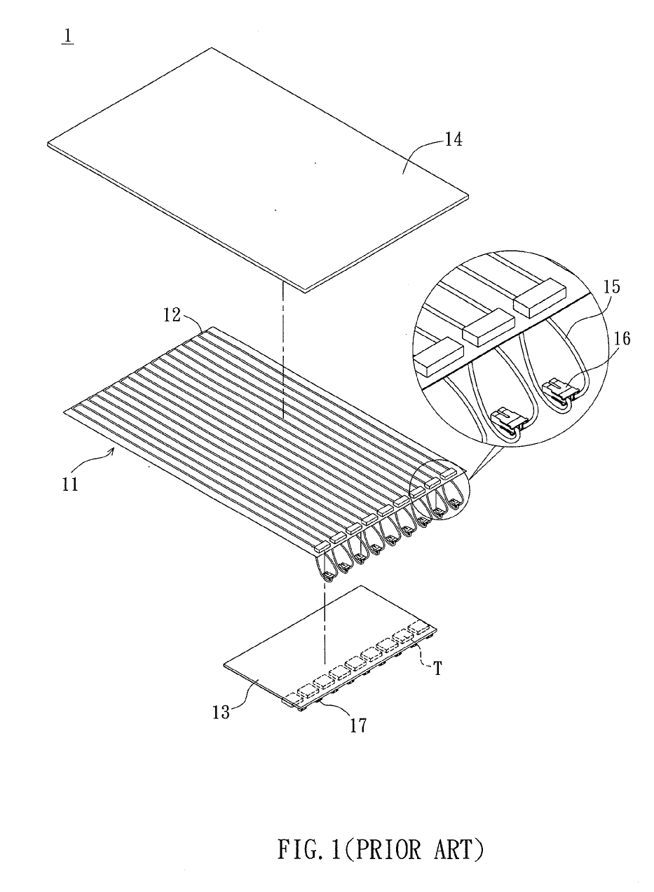

### DETAILED DESCRIPTION OF THE INVENTION

The present invention will be apparent from the following detailed description, which proceeds with reference to the accompanying drawings, wherein the same references relate to the same elements.

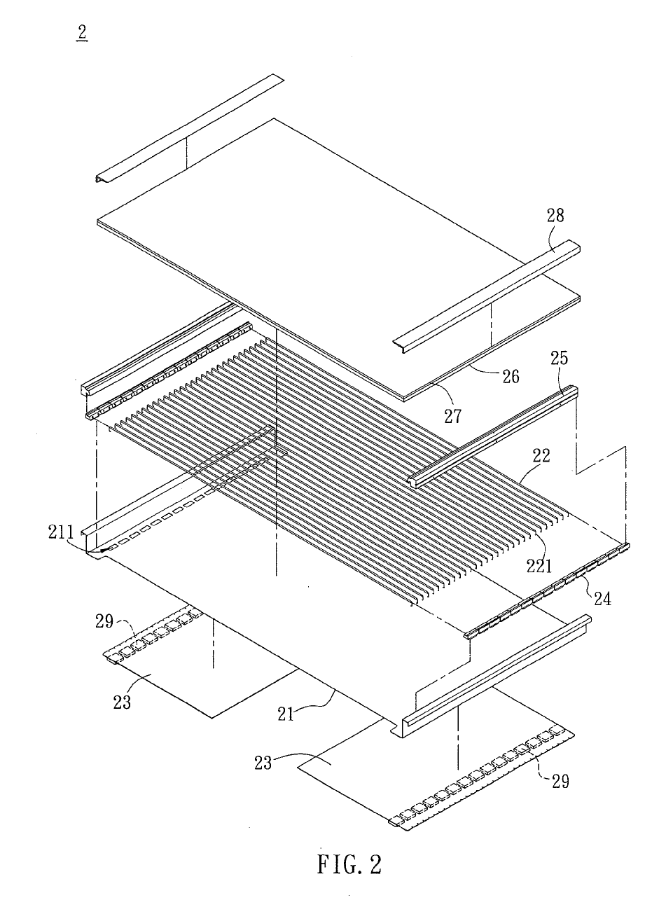

With reference to FIG. 2, a light emitting module 2 according to a preferred embodiment of the invention includes a back plate 21, at least one fluorescent lamp 22 and a circuit board 23. In the embodiment, the light emitting module 2 is, for example but not limited to, a direct-type backlight module of a LCD. In addition, the light emitting module 2 can be a side-edge backlight module, an illumination device, a light source module of an outdoor media board or a light source module of other electronic devices.

The back plate 21 has a plurality of first openings 211. The material of the back plate 21 is usually plastic, metal or alloy. The fluorescent lamp 22 is disposed on a surface of the back plate 21.

The fluorescent lamp 22 has two ends, and each end is disposed with an electrode wire 221. Each electrode wire 221 is disposed corresponding to one of the first openings 211. The fluorescent lamp 22 can be a cold cathode fluorescent lamp or a hot cathode fluorescent lamp. In the embodiment, the shape and the type of the fluorescent lamp 22 are not limited. For example, the shape of the fluorescent lamp 22 can be linear, U-shaped, C-shaped, S-shaped or W-shaped. The first opening 211 can be a through hole or a recess. For example, as shown in FIG. 2, the fluorescent lamp 22 is linear, and the first opening 211 is a through hole.

The circuit board 23 of the embodiment is a driving circuit board for driving and controlling the fluorescent lamp 22 to emit light. The circuit board 23 is disposed on the other surface of the back plate 21.

A plurality of transforming units 29 (shown as the dotted lines) are disposed on one surface of the circuit board 23, which is away from the back plate 21, for providing the high-voltage signal to the fluorescent lamp 22. The transforming unit 29 of the embodiment can be a transformer, and, in practice, the size, shape and type of the transforming unit 29 are not limited.

In addition, the light emitting module 2 can further include a plurality of lamp rubbers 24, two lamp holders 25, a diffuser 26, an optical film assembly 27 and a frame 28. In the embodiment, the lamp rubbers 24 can cover the two ends and the electrode wires 221 of the fluorescent lamp 22 for protection and insulation. The lamp holders 25 can hold the lamp rubbers 24 for fixing the lamp rubbers 24 on the back plate 21. The diffuser 26 is disposed on the lamp holders 25 for diffusing the light emitted from the fluorescent lamp 22. The optical film assembly 27 is disposed on the diffuser 26 for concentrating the diffused light so as to enhance the front luminance. In this case, the optical film assembly 27 may include a bottom diffusing sheet, a prism sheet and a top diffusing sheet. The frame 28 is locked with the lamp holders 25 so as to enhance the fixing function.

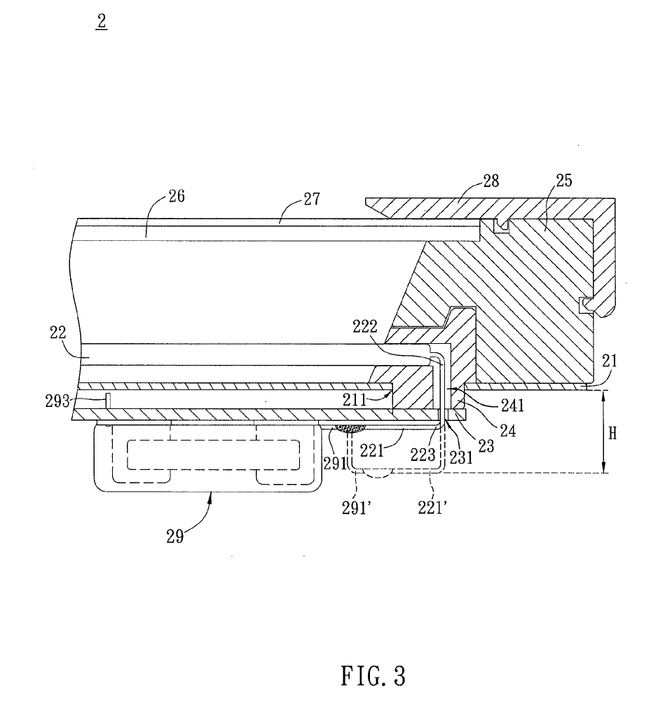

FIG. 3 is a sectional view showing a part of the assembled light emitting module 2 of FIG. 2. As shown in FIG. 3, one end of the fluorescent lamp 22 is inserted into the lamp rubber 24. The electrode wire 221 of the fluorescent lamp 22 has a bending portion 222 disposed adjacent to the fluorescent lamp 220, so that the electrode wire 221 can pass through a third opening 241 of the lamp rubber 24, the first opening 211 of the back plate 21 and a second opening 231 of the circuit board 23. The electrode wire 221 further has another bending portion 223, so that the electrode wire 221 can directly connect with the pin 291 of the secondary side of the transforming unit 29 (the high-voltage coil) by soldering, welding, melting, riveting, pressing or laser welding. Of course, if the size of the circuit board 23 is smaller, the second opening 231 may be not needed, and the electrode wire 221 can route along the edge of the circuit to directly connect with the pin 291. Moreover, if the lamp rubber 24 is not configured, the electrode wire 221 does not have to pass through the third opening 241 of the lamp rubber 24.

In the embodiment, the pin. 291 of the transforming unit 29 is extended outwardly from the body of the transforming unit 29 and then extended in a direction parallel to the back plate 21. The junction of the electrode wire 221 and the pin 291 can be suspended or covered by an insulating material as the surface of the electrode wire 221, so that the junction can be disposed on the surface of the circuit board 23. To be noted, the pin 291′ of the transforming unit 29 can be extended in a direction away from the back plate 21. For example, as the dotted lines in FIG. 3, the pin 291′ is extended perpendicular to the back plate 21, and the length of the electrode wire 221′ of the fluorescent lamp 22 is increased so as to be welded with the pin 291′. Accordingly, the distance H between the electrode wire 221′ and the back plate 21 can be increased for reducing the signal interference. In the prior art, the distance between the circuit board and the back plate is increased for enlarging the distance between the electrode wire and the back plate, and this will enlarge the size of the whole device. In contrary, the present embodiment can enlarge the distance H to decrease the signal interference without changing the whole size of the device.

In the embodiment, the primary side (low-voltage coil) of the transforming unit 29 has a pin 293, which is inserted into the circuit board 23 by the DIP process so as to electrically connected with a circuit layer (not shown) of the circuit board 23. The circuit layer can be disposed on a side of the circuit board 23, which faces the back plate 21. Thus, the circuit board 23 of the embodiment can be a single-layer circuit board. Compared with the dual-layer circuit board of the prior art, the present embodiment uses the single-layer circuit board so that the material cost can be decreased.

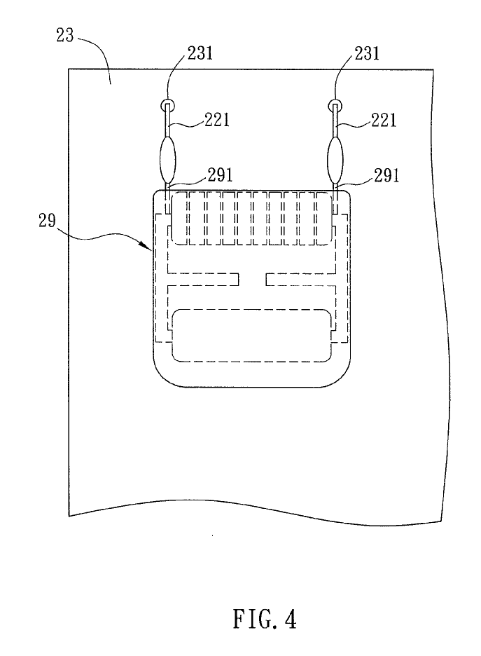

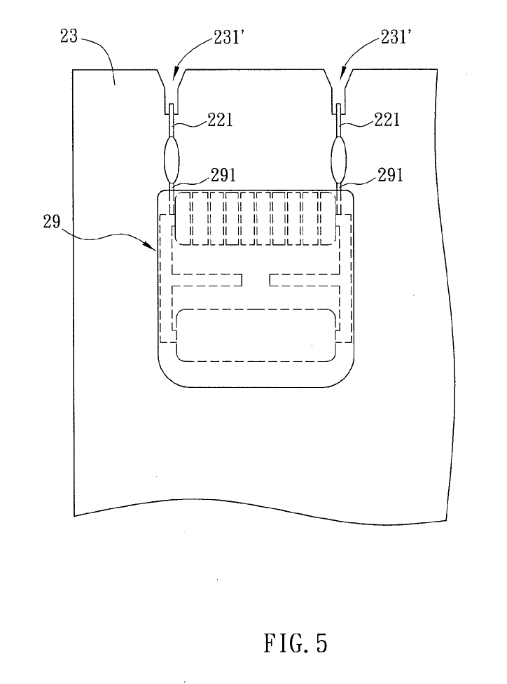

FIG. 4 is a top view of the assembled light emitting module 2 of FIG. 2. As shown in FIG. 4, the second opening 231 of the circuit board 23 is a circular through hole, so that the electrode wire 221 can pass through the second opening 231. In addition, FIG. 5 shows another aspect of the second opening 231′ of the present embodiment. In this case, the second opening 231′ is a recess disposed on the edge of the circuit board 23.

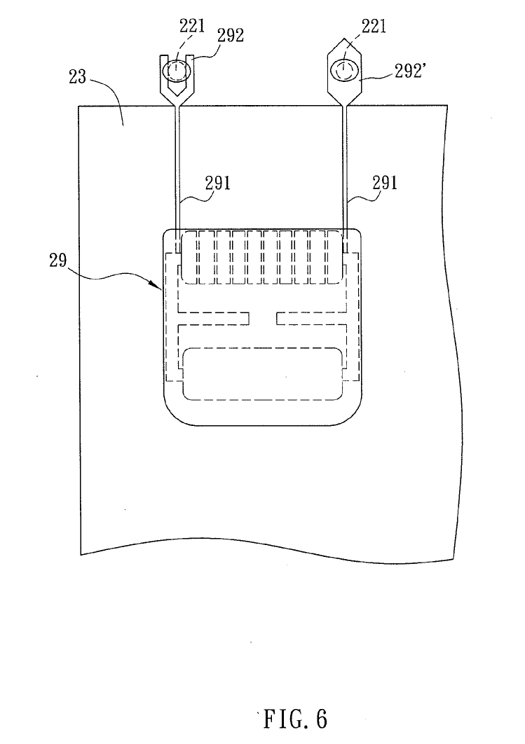

FIG. 6 shows a various aspect of the pin 291 of the embodiment. As shown in FIG. 6, the pins 291 are extended outwardly from the body of the transforming unit 29 and are protruded from the circuit board 23, and the ends of the pins 291 have connecting portions 292 and 292′, respectively. In this case, the pin 291 is disposed on the surface of the circuit board 23. The electrode wires 221 are welded to the connecting portions 292 and 292′ of the pins 291, respectively. The shape of the connecting portions 292 and 292′ can be, for example but not limited to, fork-shaped or ring-shaped for simplifying the connection and strengthening the connections of the connecting portions 292 and 292′. In addition, the shape of the electrode wires 221 are L-shaped.

To sum up, in the light emitting module of the invention, the electrode wire of the fluorescent lamp is directly connected with the pin of the transforming unit, so that the fluorescent lamp can emit light according to the high-voltage signal from the transforming unit. Compared with the prior art, the present invention does not need the expensive high-voltage flexible wire and connector, and the connecting terminals disposed on the driving circuit board are not necessary. Thus, the present invention can sufficiently decrease the material cost and simplify the control of the raw materials.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A light emitting module, comprising:
a back plate;
at least one fluorescent lamp disposed on a surface of the back plate and having an electrode wire;
a circuit board disposed on another surface of the back plate; and
a transforming unit disposed on the circuit board and having at least one pin, wherein the electrode wire connects with the pin directly.

2. The light emitting module according to claim 1, wherein the back plate further comprises a first opening, and the electrode wire passes through the first opening.

3. The light emitting module according to claim 2, wherein the first opening is a through hole or a recess.

4. The light emitting module according to claim 1, wherein the circuit board has at least one second opening, and the electrode wire passes through the second opening to connect with the pin.

5. The light emitting module according to claim 4, wherein the first opening is a through hole or a recess.

6. The light emitting module according to claim 1, wherein the pin is extended outwardly from a main body of the transforming unit.

7. The light emitting module according to claim 6, wherein the pin is extended in a direction away from the back plate.

8. The light emitting module according to claim 6, wherein the pin is extended in a direction parallel to the back plate.

9. The light emitting module according to claim 1, wherein the pin has a connecting portion, and the electrode wire connects with the connecting portion.

10. The light emitting module according to claim 9, wherein the connecting portion is fork-shaped or ring-shaped.

11. The light emitting module according to claim 1, wherein the circuit board is a single-layer circuit board.

12. The light emitting module according to claim 1, wherein the junction of the electrode wire and the pin is suspended.

13. The light emitting module according to claim 1, wherein the transforming unit is a transformer.

14. The light emitting module according to claim 1, wherein the electrode wire has a first bending portion disposed adjacent to the fluorescent lamp.

15. The light emitting module according to claim 14, wherein the electrode wire further has a second bending portion disposed adjacent to the circuit board.

16. The light emitting module according to claim 1, wherein the electrode wire and the pin are connected by soldering, welding, melting, riveting, pressing or laser welding.
